(19) United States
(12) Patent Application Publication
(10) Pub. No.: US 2002/0067291 A1
(43) Pub. Date: Jun. 6, 2002

(54) System for toll payment and transportation management

(75) Inventor: Saburou Ikeda, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/893,706

(22) Filed: Jun. 29, 2001

(30) Foreign Application Priority Data
Jul. 3, 2000 (JP) 2000-201498

(51) Int. Cl. G08G 1/065

(52) U.S. Cl. 340/928; 340/539; 235/380

(57) ABSTRACT

An object of the present invention is to pay a toll without stopping a car and without providing a special lane for electronic payment, thereby reducing a traffic jam. The toll payment system comprises a portable telephone on a car, a base station connected with the portable telephone, a server connected with the base station. The server comprises a first memory for storing a location of the base station, a second memory for storing a unit price for each section along the highway and data identifying a contractor or contracted car, a driving route identification unit for identifying a driving route on the basis of the location stored in the first memory and a base station connected under a certain manner, a toll calculation, and a charging unit.

### BACKGROUND OF THE INVENTION

1. Technical Field of the Invention

The present invention relates to an electronic toll payment system for a highway toll and a transportation management system.

2. Description of the Prior Art

Toll payments at a gate cause usually a traffic jam. Therefore, prepaid cards and coupon tickets are used for shortening time spent for the payment. Further, wireless communication is used for an electronic payment without stopping a car, as disclosed in JP 6-59947 U (1994).

Further, a portable telephone is used in JP 11-110593 A (1999) for avoiding special apparatus.

However, these electronic payments as mentioned above require an apparatus for identifying a car which passes the toll gate.

The identifying apparatus at the gate is large-scaled, because it has to determine, for preventing unfair actions, a toll which depends upon a car size, driving distance and driving section on the highway, on the basis of distinctive features of the car or a special apparatus mounted on the car.

The conventional toll payment has a disadvantage that special lanes for the electronic payment must be provided together with conventional lanes for cash and prepaid cards. Therefore, the traffic jam at the gate may become heavier, in spite of the fact that it costs much to construct these lanes.

### SUMMARY OF THE INVENTION

An object of the present invention is to use portable telephone for the electronic toll payment, thereby avoiding special lanes, passing cars without stop, and reducing the traffic jam.

A portable telephone in a car is used in the present invention. Further, the portable telephone may be provided with a GPS function. Further, the portable telephone may be connected with GPS apparatus such as a car navigation system which includes a display, an audio and video device, and an input device. Such portable telephone dials up an internet service provider (ISP) and sends a car ID and password. When ISP confirms an account for electronic payment, ISP requests location information and a telephone number of the portable telephone.

After receiving the location information, ISP searches a radio base station relevant to the location information and transmits a name of an entrance toll gate by a voice guidance or data signal. The portable telephone responds the voice guidance. When the portable telephone confirmed and responds the name and existence of the guided entrance toll gate, the connection with that portable telephone is temporarily disconnected, after a guidance of starting the electronic payment.

ISP transmits, to the toll gate, the information that a car with a contraction of an electronic payment passes the gate, thereby recording the car by using a monitoring video camera, in synchronization with the information from ISP, if necessary.

Hereafter, ISP inquires a telephone company who controls the portable telephone, in order to know the location of the portable telephone.

Even when the car is in a tunnel, the portable telephone on the car may be captured by a location registration by utilizing a leakage coaxial cable, on the basis of a request from ISP. The captured result is transmitted to ISP through the internet.

Thus, a driving route of the car is reliably grasped and the toll is calculated on the basis of the grasped driving route.

The toll gate does not need to identify a kind of car, because the car ID in accordance with the kind of car is transmitted to ISP.

GPS may be needless, when a barrier is provided at the toll gate to shield electromagnetic waves from conventional radio base stations and when a radio base station exclusively used for each toll gate is provided.

ISP may be informed of passages of cars by using special apparatuses which operates only a vicinity of the toll gate, such as a portable telephone which can be used within a relatively narrow zone near the toll gate. The driving route is grasped and the toll is calculated on the basis of the information of passages of cars.

According to the present invention, the toll gate does not need to identify a kind of car, because the kind of car is identified by the car ID transmitted to ISP. Further, any special transmission channel is not required, because conventional portable telephone is used. Further, any special apparatus for identifying car location, because the location information offered by the portable telephone, or GPS is used. Further, various internet electronic payment system can be used, because the car is connected with ISP. Further, the toll gate does not need to identify the driving distance and section, because the location information from the telephone company can be utilized. Further, unfair actions are prevented and safety of highway is supervised by the monitoring video camera. Thus, facilities cost is reduced greatly.

The above-mentioned cost reduction causes further cost reduction in toll collection and all the other communication costs and further reduction of the traffic jam at the toll gate.

According to the present invention, not only an electronic payment system for highway toll without stopping a car, but also a cash-less system in a service area, and freight truck management system are provided.

### BRIEF EXPLANATION OF THE DRAWINGS

FIG. 1 is a block diagram of the electronic payment system for highway toll of the present invention.

FIG. 2 is a flow chart of steps S1 to S6 of the electronic payment of highway toll of the present invention.

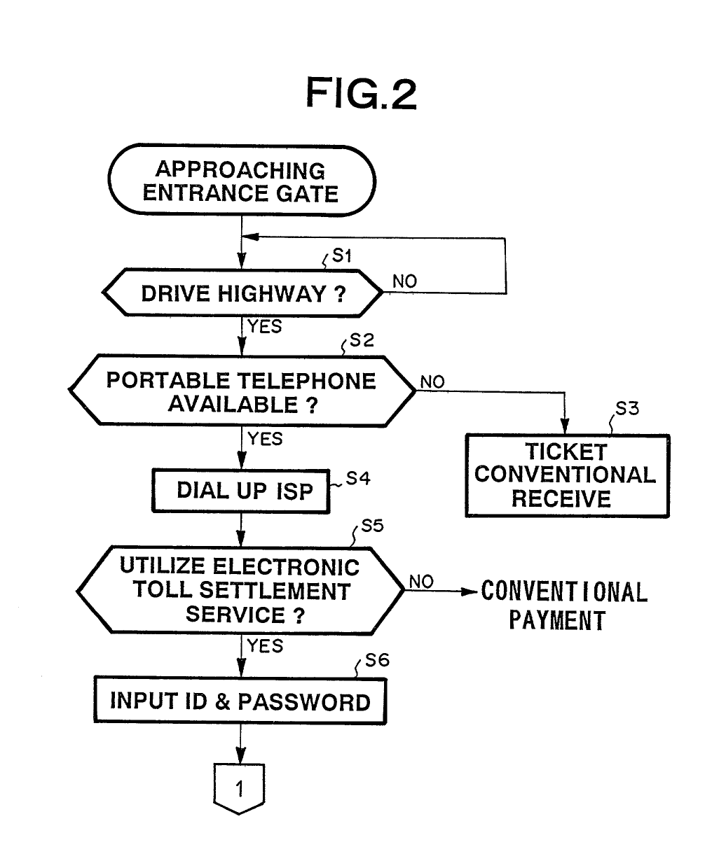

FIG. 3 is a flow chart of steps S7 to S14 of the electronic payment of highway toll of the present invention.

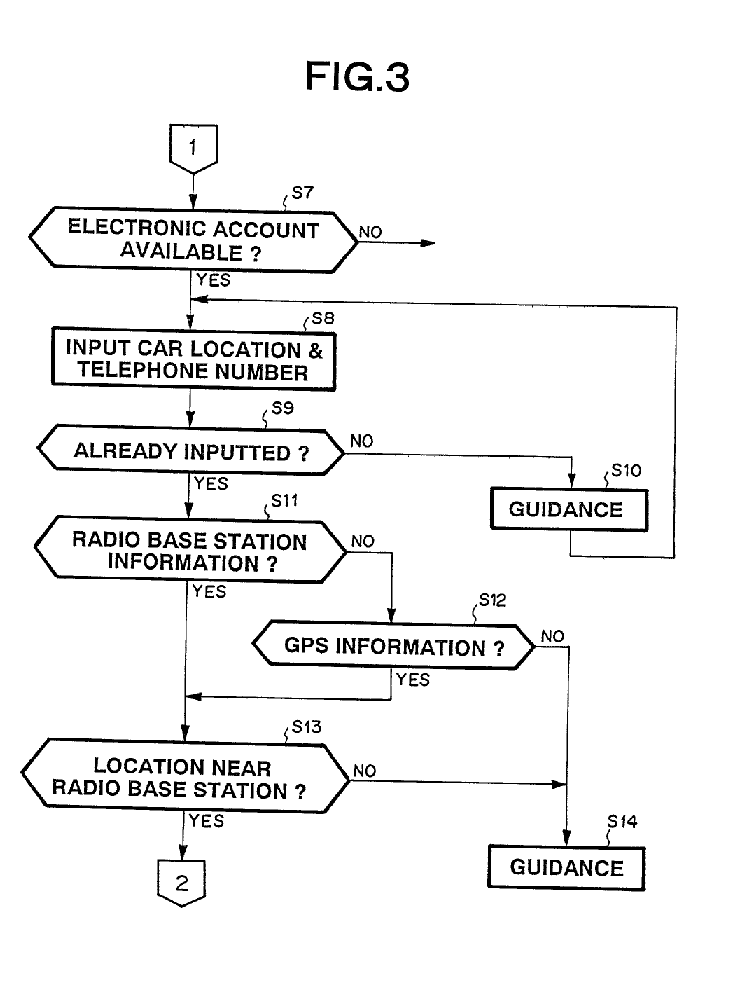

FIG. 4 is a flow chart of steps S15 to S23 of the electronic payment of highway toll of the present invention.

FIG. 5 is a flow chart of steps S24 to S32 of the electronic payment of highway toll of the present invention.

FIG. 6 is a flow chart of steps S33 to S44 of the electronic payment of highway toll of the present invention.

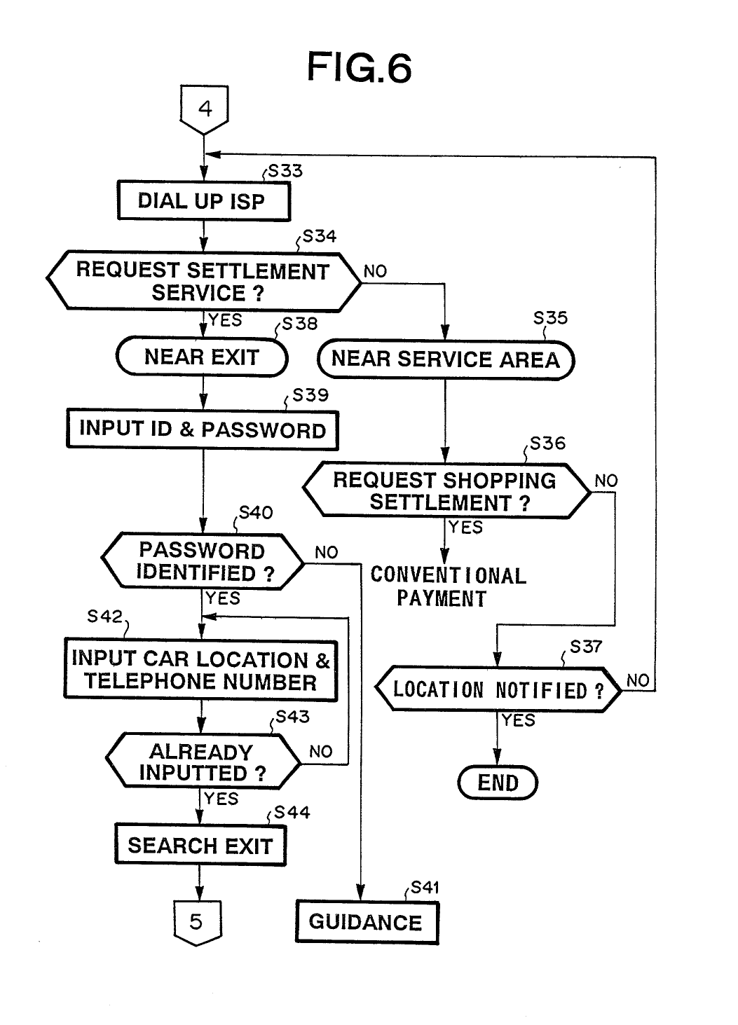

FIG. 7 is a flow chart of steps S45 to S53 of the electronic payment of highway toll of the present invention.

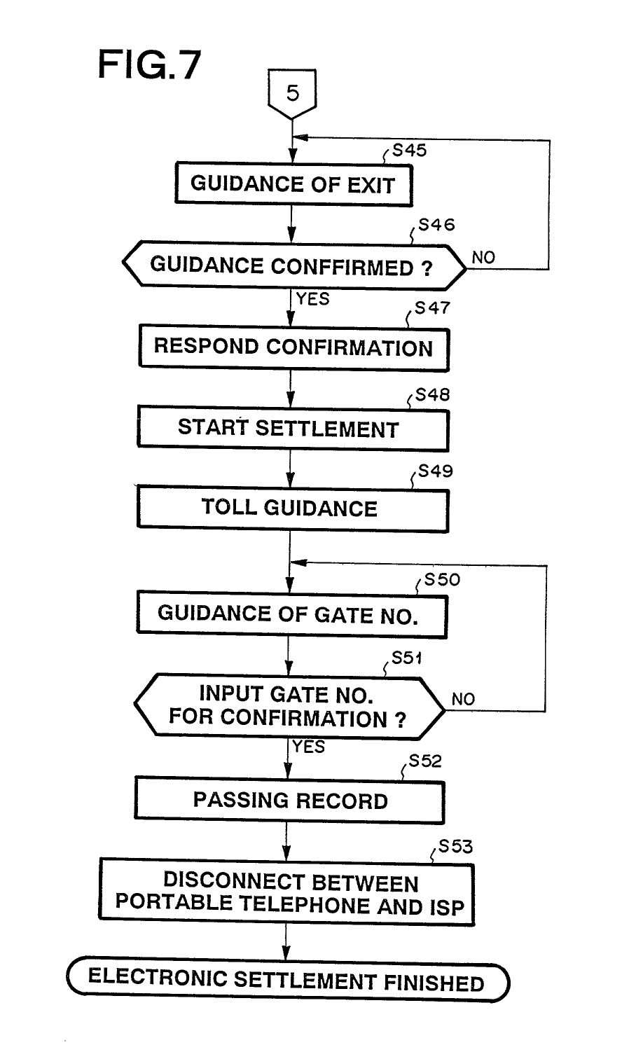

### PREFERRED EMBODIMENT OF THE INVENTION

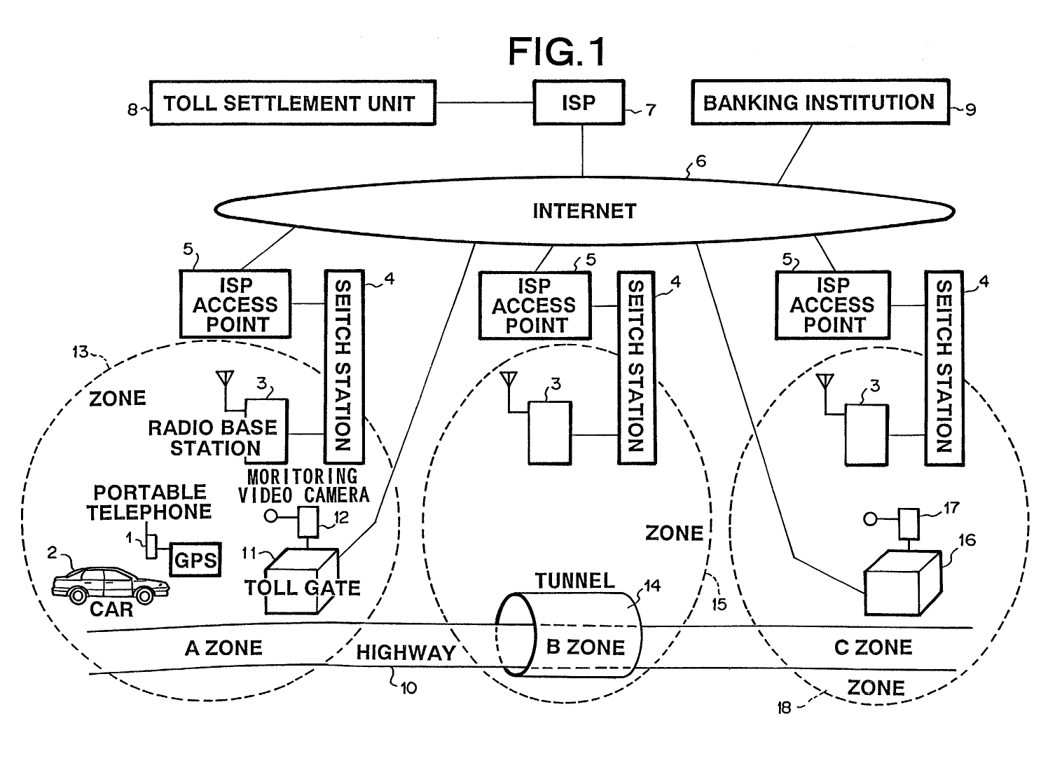

FIG. 1 is a block diagram of an embodiment of the present invention.

Portable telephone 1 is an information terminal carried by a driver of car 2. Portable terminal 1 is connected with radio base station 3 which is connected, through switch station 4 and ISP access point 5, with internet 6. Further, internet 6 is connected through ISP 7 with toll payment unit 8. Further, a sever or toll payment unit 8 is connected through internet 6 with banking institution 9.

Radio base stations 3 are provided at prescribed locations along a highway. Concretely, entrance toll gate 11 is provided with monitoring video camera 12 for photographing car 2 passing through entrance toll gate 11. Radio base station 3 at entrance toll gate 11 communicates with portable telephone 1 in radio zone A 13. Other radio base station 3 which controls radio zone B 15 communicates with portable telephone 1, although it can not communicate with portable telephone 1, when portable telephone 1 is in tunnel 14 where the electromagnetic wave is shielded. Further, Exit toll gate 16 is provided with monitoring video camera 17, while another radio base station 3 communicates with car 2 in radio zone C 18 near exit toll gate.

A single radio zone B is shown in between the entrance and exit. The more the radio zones in between the entrance and exit, the higher the accuracy of tracking car 2. Further, when radio zone B includes tunnel 14, it has an advantage to confirm that car 2 passes through tunnel 14, if the communication with portable terminal 1 is ceased for a period longer than a prescribed time period. Alternatively, a leakage coaxial cable may be provided in tunnel 14, thereby communicating with another radio base station exclusively used for tunnel 14. In this case, a passage of car 2 through tunnel 14 is positively determined by the special radio base station. Alternatively, a certain area such as a service area may be utilized, for determining a passage of car 2, on the basis of a characteristic communication state near the certain area. Further, radio base station 3 may be used exclusively for toll collection system of the present invention. Furthermore, periodical registration of location of portable telephone executed by a conventional radio base station may be utilized.

Next, the toll collection is explained, referring to the flow charts.

When car 2 approaches toll gate 11 along highway 10 and the driver wishes to drive into highway 10 (S1, S2), the driver dials the number of nearby ISP access point 5 (S4), in order to utilize an electronic payment of toll. The dialing may be manually executed by the driver, or may be automatically executed on the basis of receiving a signal for indicating that car 2 is approaching a toll gate. When the driver is not equipped with a portable telephone, the driver proceeds to a conventional receipt of ticket or a conventional payment of toll (S3).

After confirming that the dial-up access is for the electronic toll payment (S4), ISP access point 5 connects the call with ISP 7 through ISP exclusive network or internet 6. ISP 7 knows a request of electronic toll payment on a service menu and entrusts further management to toll payment unit 8. Toll payment unit 8 transmits voice guidance or voice guidance data to portable telephone 1 in order to obtain car ID (S6).

It is assumed that the Car ID is number plate information. When toll payment unit 8 controlled by ISP 7 gets the number plate information, ISP 7 searches user information stored in a memory in toll payment unit 8 in order to confirm that a preliminary set-up for the electronic payment is already completed. Further, ISP 7 searches on-line cash information in the user information in order to confirm that the toll is payable or an account exists (S7, S8, S9).

When the balance of the account is smaller than the toll, the voice guidance or voice guidance data is sent through toll payment unit 8 to portable telephone 1 in order to inquire whether or not to access banking institution 9 connected with ISP 7 through internet 6 (S10).

Then, when portable telephone 1 is connected, ISP 7 confirms information for identifying radio base station 3 (S11). When the information is not confirmed, ISP 7 confirms GPS information (S12). On the basis of these information, the location of car 2 is deemed to be confirmed, referring to the data base concerning the location of radio base station 3. On the other hand, when GPS information is not confirmed in S12, or when the location of car 2 is not confirmed in S13, conventional toll payment is recommended, by sending a guidance not to utilize the electronic toll payment (S14).

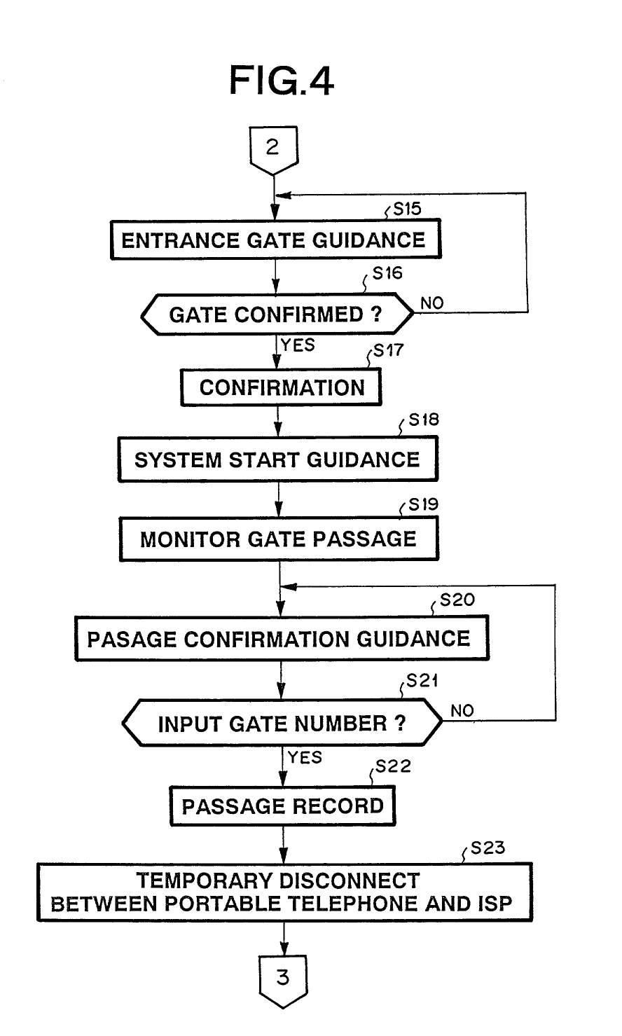

ISP 7 secures on-line cash in banking institution 9, when necessary. When the on-line cash is already secured, ISP 7 urge portable telephone 1 to input a password. Then, after confirming the password, ISP 7 instruct the entrance toll gate 11, thereby sending a guidance instructing dialing a number identifying the gate number, when car 2 passes entrance toll gate 11 (S15), as shown in FIG. 4. Portable telephone 1 in car 2 dials the number identifying the gate number, after confirming the guidance (S16), and responds that car 2 is passing the guided entrance (S17). The response may be automatic as already mentioned.

Then, a guidance to start the electronic payment is sent to portable telephone 1 (S18), and then, a guidance to instruct to confirm passing entrance toll gate 11 (S19). After confirming that car 2 passed entrance toll gate 11 (S20), the gate number is inputted by portable telephone 1 (S21). Then, passing record is made (S22), thereby stopping temporarily the connection with portable telephone 1 (S23).

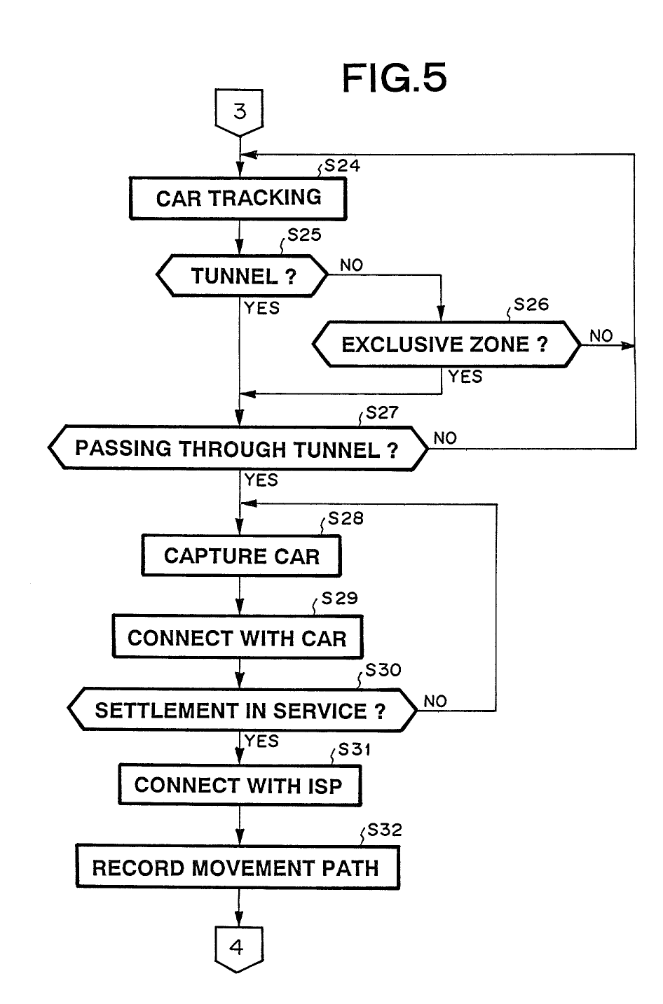

Hereafter, toll payment unit 8 tracks car 2 (S24), as shown in FIG. 5.

As already mentioned, when the electromagnetic wave is received again after an interruption due to a tunnel for more than a prescribed period of time such as a prescribed period of time for the location confirmation, a conventional location registration is tried by radio base station 3 which controls each area of the highway.

Toll payment unit 8 tracking car 2, by collecting the location registration information through internet or other network. Concretely, it is determined whether car 2 has passed tunnel 14 along highway 10, on the basis of the interruption of communication for more than the prescribed period of time (S25). Alternatively, it is determined whether car 2 is connected with radio base station 3 for a specified area in tunnel 14 (S26). A passage through tunnel 14 is determined (S27) either by S25 or S26. Then, portable telephone 1 in car 2 is captured (S28) and connected (S29). Further, when it is confirmed that electronic payment service is effective for car 2 (S30), portable telephone 1 in car 2 is connected with ISP 7 (S31), thereby recording a driving route of car 2 which has passed tunnel 14, referring to the database for tunnel 14 and its location (S32).

The location registration of car 2 is not renewed, when car 2 takes a rest in a service area, runs through a long tunnel or a mountain area, although the location registration of car 2 is renewed for an arbitrary period of time. Therefore, when the location registration is not renewed for a prescribed time period, or when the user wishes to know the necessary electronic cash, toll payment unit 8 calls periodically portable telephone 1, thereby sending a guidance for toll or location confirmation and instructing an input of necessary data. When a plurality of tunnels exists in an area, the tracking of car 2 may be conducted only by connecting radio base station 3 which controls that area.

The location registration is not renewed for a long time, or the periodical call from toll payment unit is not received for a long time, probably due to a shortage or stoppage of battery or other causes. In this case, the driving route is not determined. Therefore, the electronic payment is cancelled, or a registration number for the electronic payment is sent to a conventional toll gate. Further, possible ways for registering an electronic payment may be provided, even when car 2 has received a conventional traffic card at an entrance gate.

Portable telephone 1 may also call ISP for selecting a service menu for paying a shopping or refueling in a service station. Such an electronic payment fills up a long time stoppage of renewal of the location information. A terminal in a store is connected through internet with a service control unit in ISP, when portable telephone dials up ISP for an electronic payment of the shopping in the service area, selects the service menu, and inputs the car ID.

Shopping in a service area may be settled, when portable telephone 1 calls ISP (S33) and does not utilize the electronic toll payment (S34).

The service area is easily identified by radio base station (S35), when portable telephone 1 requests the electronic payment in that service area. Portable telephone 1 may input a serial number of a cash register, even when a hard cash is requested by the store. Then, ISP is connected through internet with that cash register, and the cash register send payment information to ISP. ISP sends a sum of money to portable telephone 1, when the payment requested by the cash register is smaller than the on-line cash. Portable telephone 1 notifies ISP of the electronic payment of the shopping, after confirming the sum of money for the shopping. The shopped goods are handed over, when ISP notifies the cash register of a completion of the payment (S36). When the electronic payment is not executed in S36, portable telephone 1 sends its location to radio base station (S37). When the location of portable telephone 1 is not notified to radio base station in S37, then S33 is executed.

In this manner, the electronic toll payment is started in A zone as shown in FIG. 1, the tracking of car 2 is conducted in B zone, and the toll payment is finished in C zone.

Portable telephone 1 manually or automatically dials up nearby ISP (S34). When car 2 approaches exit gate 16 (S38), portable telephone 1 inputs car ID and its password (S39) in accordance with a guidance of ISP which in turn notifies toll payment unit 8 of the car ID. When the inputted password is identified (S40), toll payment unit 8 starts rapidly obtaining information for deciding an exit gate, by inquiring switch station 4 of the location of radio base station 3 which controls the zone where portable telephone 1 exists (S42). Toll payment unit 8 may also requests, to portable telephone, GPS location information. On the other hand, when the inputted password is not correct In S40, toll payment unit 8 notifies portable telephone 1 of a guidance that electronic payment service is not executed (S41).

After obtaining the location information, car ID and the location registration (S43), toll payment unit 8 searches an exit gate (S44), and inquires exit gate 16 whether or not the searched exit gate is the same as the car driver sees (S45). When they are the same (S46), portable telephone 1 responds that they are the same (S47). Then, toll payment unit 8 calculates a toll for the driving route and starts the toll payment (S48). Then, a guidance of toll information for preventing a miscalculation (S49) and a guidance of exit gate (S50 ) are sent to portable telephone 1. Further, the exit gate number is inputted by portable telephone 1 for a confirmation (S51). The electronic accounting of the toll is finished by the input of the exit gate number. Then, monitor video camera is switched on for monitoring that car 2 goes out of the highway (S52). The electronic payment toll payment is finished by a prescribed dialing, when car 2 passes the exit gate, and portable telephone 1 is disconnected with ISP (S53).

The present invention is applied not only to the toll payment, but also to electronic payment of shopping in a service area and refueling in a service station, and traffic management in transportation companies.

For example, it is assumed that a freight truck departed from a truck terminal. The contents of freight and a truck ID are stored in a service control unit in ISP. The portable telephone in the truck dials up ISP, selects a service menu, and inputs the truck ID, at the time of departure. In accordance with the ID input, the tracking of the freight truck is started by the service control unit in ISP. Hereafter, an arrival time may be sent to the truck or the truck terminal. The present freight state may be renewed at times of load and unload, by inputting or scanning freight numbers. Safe arrivals to destinations may be notified. Such items are managed by the service control unit in ISP.

Each truck terminal is a counterpart of the highway toll gate. The truck terminal may be shared by a plurality of transportation companies. In this case, an available gate number in a warehouse is notified to portable telephone, in accordance with the truck ID. Further, a list of load and unload is notified and confirmed by ISP.

What is claimed is:

1. A toll payment system which comprises:
a portable telephone on a car of a contractor of electronic toll payment service;
base stations connected with said portable telephone; and
a server connected with said base stations,
wherein said server comprises:
a first memory for storing locations of said base stations;
a second memory for storing names of contractors or their car numbers and unit toll for each section along a highway;
a driving route identification unit for identifying a driving route of said portable telephone on the basis of said locations of said base station which are connected with said portable telephone;
a toll calculation unit for calculating a toll on the basis of said unit toll and the identified driving route; and
a toll charging unit for charging said portable telephone the calculated toll.

2. A toll payment system which comprises:
a portable telephone on a car of a contractor of electronic toll payment service;
base stations connected with said portable telephone; and
a server connected with said base stations,
wherein:
said portable telephone comprises GPS unit for identifying its location,
said server comprises:
a second memory for storing names of contractors or their car numbers and unit toll for each section along a highway;
a driving route identification unit for identifying a driving route of said portable telephone on the basis of said locations measured by said GPS unit;
a toll calculation unit for calculating a toll on the basis of said unit toll and the identified driving route; and
a toll charging unit for charging said portable telephone the calculated toll.

3. The toll payment system according to claim 1, wherein said server comprises gate means for passing said car on the basis of finishing said toll payment.

4. The toll payment system according to claim 2, wherein said server comprises gate means for passing said car on the basis of finishing said toll payment.

5. The toll payment system according to claim 1, wherein said server comprises notification means for notifying said portable telephone of an exit lane on the basis of finishing said toll payment.

6. The toll payment system according to claim 2, wherein said server comprises notification means for notifying said portable telephone of an exit lane on the basis of finishing said toll payment.

7. The toll payment system according to claim 1, wherein said driving route identification unit identifies said driving route of said portable telephone on the basis of connection states between said mobile station and said base stations.

8. The toll payment system according to claim 7, wherein said base stations are connected with said portable telephone located at a tunnel, toll gate, or a service area along said driving route.

9. The toll payment system according to claim 1, wherein said driving route identification unit identifies said driving route of said portable telephone on the basis of connection states between said portable telephone and a base station which includes a region where an exterior magnetic wave is shielded, but can be connected with said portable telephone.

10. The toll payment system according to claim 2, wherein said driving route identification unit identifies said driving route of said portable telephone on the basis of connection states between said portable telephone and a base station which includes a region where an exterior magnetic wave is shielded, but can be connected with said portable telephone.

11. The toll payment system according to claim 1, wherein said toll charging means charges said calculated toll, when a balance for said portable telephone is greater than said calculated toll.

12. The toll payment system according to claim 2, wherein said toll charging means charges said calculated toll, when a balance for said portable telephone is greater than said calculated toll.

13. The toll payment system according to claim 1, wherein said toll charging means charges said calculated toll, when said portable telephone communicates with said base stations every prescribed time interval.

14. The toll payment system according to claim 2, wherein said toll charging means charges said calculated toll, when said portable telephone communicates with said base stations every prescribed time interval.

15. The toll payment system according to claim 1, wherein said server further comprises a third memory for storing an ID of said portable telephone, wherein said name of contractor and its car ID are identified by said ID of said portable telephone.

16. The toll payment system according to claim 2, wherein said server further comprises a third memory for storing an ID of said portable telephone, wherein said name of contractor and its car ID are identified by said ID of said portable telephone.

17. A toll payment method using a portable telephone on a car of a contractor of electronic toll payment service, base stations connected with said portable telephone and a server connected with said base stations, which comprises the steps of:
storing names of contractors or their car numbers and unit toll for each section along a highway;
identifying a driving route of said portable telephone on the basis of said locations of said base station which are connected with said portable telephone;
calculating a toll on the basis of said unit toll and the identified driving route; and
charging said portable telephone the calculated toll.

18. A toll payment method using a portable telephone with GPS unit on a car of a contractor of electronic toll payment service, base stations connected with said portable telephone and a server connected with said base stations, which comprises the steps of
storing names of contractors or their car numbers and unit toll for each section along a highway;
identifying a driving route of said portable telephone on the basis of said locations measured by said GPS unit;
calculating a toll on the basis of said unit toll and the identified driving route; and
charging said portable telephone the calculated toll.

19. A computer program product for executing a toll payment method using a portable telephone on a car of a contractor of electronic toll payment service, base stations connected with said portable telephone and a server connected with said base stations, which records the steps of:
storing names of contractors or their car numbers and unit toll for each section along a highway;
identifying a driving route of said portable telephone on the basis of said locations of said base station which are connected with said portable telephone;
calculating a toll on the basis of said unit toll and the identified driving route; and
charging said portable telephone the calculated toll.

20. A computer program product for executing a toll payment method using a portable telephone with GPS unit on a car of a contractor of electronic toll payment service, base stations connected with said portable telephone and a server connected with said base stations, which records the steps of:
storing names of contractors or their car numbers and unit toll for each section along a highway;
identifying a driving route of said portable telephone on the basis of said locations measured by said GPS unit;
calculating a toll on the basis of said unit toll and the identified driving route; and
charging said portable telephone the calculated toll.

21. A transportation management system which comprises:
a portable telephone;
radio base stations connected with said portable telephone in their communication areas; and
a server connected with said radio base stations,
wherein said server comprises:
a first memory for storing said radio base stations and their locations;
a second memory for storing a name of contractor of said portable telephone and a number of car of said contractor; and
a driving route identification unit for identifying a driving route of said car on the basis of the location stored in said first memory of the radio base station connected with said portable telephone.

22. The transportation management system according to claim 21, wherein said driving route is identified on the basis of the location stored in said first memory of the radio base station which includes a section where exterior electromagnetic wave is shielded, but can be connected with said portable telephone.

23. A computer program product for a transportation management system which records the steps of:
storing a name of contractor of said portable telephone and a number of car of said contractor and tolls for each section;
identifying a driving route of said car on the basis of the location of the radio base station connected with said portable telephone, particularly identifying said driving route on the basis of the location stored in said first memory of the radio base station which includes a section where exterior electromagnetic wave is shielded, but can be connected with said portable telephone.
